(19) United States
(12) Patent Application Publication
(10) Pub. No.: US 2011/0158640 A1
(43) Pub. Date: Jun. 30, 2011

(54) Chirp measuring device and chirp measurement method

(75) Inventor: Hirotomo Izumi, Kawasaki (JP)

(73) Assignee: FUJITSU OPTICAL COMPONENTS LIMITED, Kawasaki (JP)

(21) Appl. No.: 12/926,865

(22) Filed: Dec. 14, 2010

(30) Foreign Application Priority Data
Dec. 28, 2009 (JP) 2009-298912

(51) Int. Cl. H04B 10/08

(52) U.S. Cl. 398/25

(57) ABSTRACT

A chirp measuring device includes a chirp measuring unit that measures chirps indicating a time variation of an optical frequency of input light signal; a signal averaging unit that computes, based on a predetermined number of additions for signal averaging, an average of the chirps measured by the chirp measuring unit; a chirp threshold value determining unit that determines whether the average computed by the signal averaging unit is not less than a predetermined chirp threshold value; and a determination result output unit that outputs a determination result obtained by the chirp threshold value determining unit.

### CROSS-REFERENCE TO RELATED APPLICATION

This application is based upon and claims the benefit of priority of the prior Japanese Patent Application No. 2009-298912, filed on Dec. 28, 2009, the entire contents of which are incorporated herein by reference.

### FIELD

The embodiments discussed herein are directed to a chirp measuring device and a chirp measurement method.

### BACKGROUND

In an optical communication system, a transmission speed that is a transfer data amount per a predetermined time tends to have a large capacity. It is required that such an optical communication system can perform high-speed communication with high reliability and be provided at a lower cost. The request for high reliability is realized by, for example, the evaluation or control of chirps that are a time variation of an optical frequency (fluctuation of optical frequency) that are measured by a chirp measuring device.

On the other hand, one of important factors for providing an optical communication system at a lower cost is, for example, to reduce the number of test processes of optical components included in the optical communication system as much as possible. In the test process of an optical component included in an optical communication system, the presence or absence of turbidity is conventionally detected by using a microscope, visual inspection, or the like. This technique has been known as disclosed in, for example, Japanese Laid-open Patent Publication No. 2007-114307.

However, in the test process of an optical component included in a conventional optical communication system, there is a problem in that the test of the optical component takes a time and has low precision. Specifically, there is a possibility that even an optical component that can be sufficiently used in actual is treated as a defect in the test process performed by a microscope, visual inspection, or the like. Moreover, the test performed by a microscope, visual inspection, or the like costs time and money by using a human resource or a high-precision microscope.

### SUMMARY

According to an aspect of an embodiment of the invention, a chirp measuring device includes a chirp measuring unit that measures chirps indicating a time variation of an optical frequency of input light signal; a signal averaging unit that computes, based on a predetermined number of additions for signal averaging, an average of the chirps measured by the chirp measuring unit; a chirp threshold value determining unit that determines whether the average computed by the signal averaging unit is not less than a predetermined chirp threshold value; and a determination result output unit that outputs a determination result obtained by the chirp threshold value determining unit.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF THE DRAWINGS

FIG. 1 is a diagram illustrating the configuration example of a chirp measuring device according to a first embodiment;

FIG. 2 is a diagram illustrating an example of a time change of a driving voltage in a phase modulator;

FIG. 3 is a diagram illustrating an example of a chirp that is a change from a carrier frequency;

FIG. 4 is a diagram illustrating an example of a phase change when a chirp occurs;

FIG. 5 is a diagram illustrating an example of a simulation result when a driving voltage driver makes the phase modulator generate a chirp;

FIG. 6 is a diagram illustrating an example of a simulation result under a condition to which a fluctuation of a carrier frequency is added;

FIG. 7 is a diagram illustrating an example of a chirp detection according to a time average;

FIG. 8 is a diagram illustrating a configuration example of an optical component testing system that includes a chirp measuring device according to a second embodiment;

FIG. 9 is a diagram illustrating a configuration example of the chirp measuring device according to the second embodiment;

FIG. 10 is a diagram illustrating an example of a time average width that is set;

FIG. 11 is a diagram illustrating an example of a process for excluding a chirp caused by a design;

FIG. 12 is a diagram illustrating an example of a determination process of a chirp error;

FIG. 13 is a flowchart of a chirp measurement process according to the second embodiment; and

FIG. 14 is a diagram illustrating an example of a computer that executes a chirp measurement program.

### DESCRIPTION OF EMBODIMENTS

Preferred embodiments of the present invention will be explained with reference to accompanying drawings. The present invention is not limited to the following embodiments.

### [a] First Embodiment

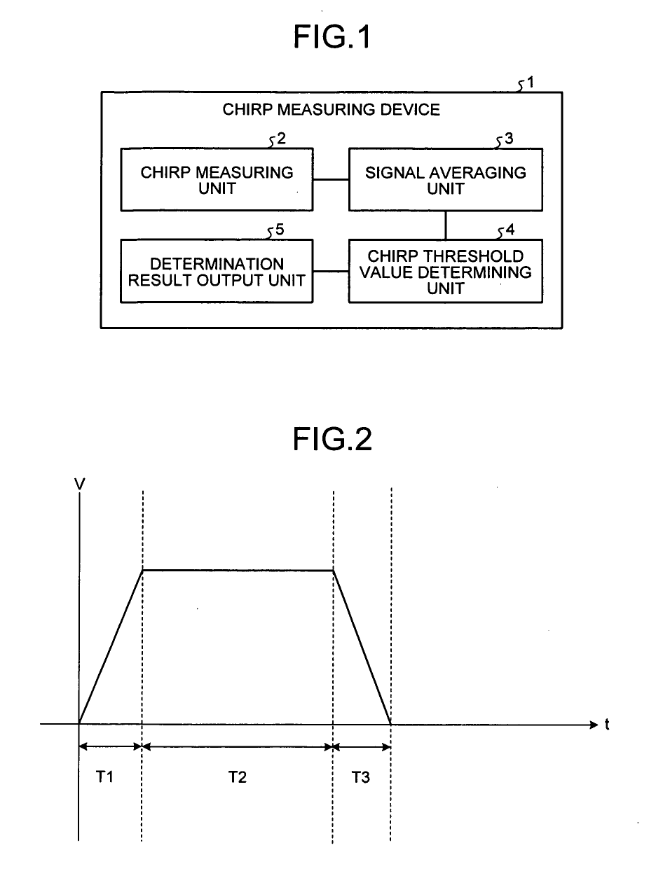

It will be explained about the configuration example of a chirp measuring device according to a first embodiment with reference to FIG. 1. FIG. 1 is a diagram illustrating the configuration example of a chirp measuring device 1 according to the first embodiment.

For example, as illustrated in FIG. 1, the chirp measuring device 1 includes a chirp measuring unit 2, a signal averaging unit 3, a chirp threshold value determining unit 4, and a determination result output unit 5. Moreover, the chirp measuring device 1 measures chirps, which indicate time variation of an optical frequency (fluctuation of optical frequency) that randomly occurs in an optical communication system, for example, from input light signal. The chirps occur not only by the fluctuation of the optical frequency, but also by the occurrence of a phase modulation when light passes through a defective part of an optical component. In other words, chirps caused when light passes through a defective part of an optical component constantly occurs.

In the above configuration, the chirp measuring unit 2 measures chirps that indicate time variation of an optical frequency of input light signal. The signal averaging unit 3 then computes, based on the predetermined number of additions, an average of chirps measured by the chirp measuring unit 2. Next, the chirp threshold value determining unit 4 determines whether the average computed by the signal averaging unit 3 is not less than a predetermined chirp threshold value. After that, the determination result output unit 5 outputs the determination result performed by the chirp threshold value determining unit 4.

As a specific example, the chirp measuring unit 2 measures, from input light signal, chirps that include a chirp caused by a fluctuation of an optical frequency and a chirp caused when light passes through a defective part of an optical component. The signal averaging unit 3 then computes a time average for each predetermined time slot by using the chirps measured by the chirp measuring unit 2. In this way, the chirp measuring device 1 smoothes chirps that occur in random order and maintains chirps that constantly occur when light passes through a defective part of an optical component.

Next, the chirp threshold value determining unit 4 determines whether the peak of the chirp that is maintained in the average computed by the signal averaging unit 3 is not less than a predetermined chirp threshold value. After that, when the determination result performed by the chirp threshold value determining unit 4 is not less than the predetermined chirp threshold value, the determination result output unit 5 outputs performance degradation information that indicates the performance degradation of the corresponding optical component.

Moreover, when the determination result performed by the chirp threshold value determining unit 4 is less than the predetermined chirp threshold value, the determination result output unit 5 outputs non-defect information indicating that the corresponding optical component is a non-defective product. In this case, the determination result output from the determination result output unit 5 is displayed, for example, on a display unit included in the chirp measuring device 1 or a predetermined display device.

As described above, the chirp measuring device 1 computes the time average of the measured chirps to detect only the chirp that constantly occurs when light passes through the defective part of the optical component, determines whether the detected chirp is not less than the threshold value, and outputs the determination result. As a result, in comparison to the conventional test process of an optical component that is performed by a microscope or a visual inspection, the chirp measuring device 1 can reduce the test time of an optical component and perform a high-precision test only by adding a simple configuration to an existing chirp measuring device.

### [b] Second Embodiment

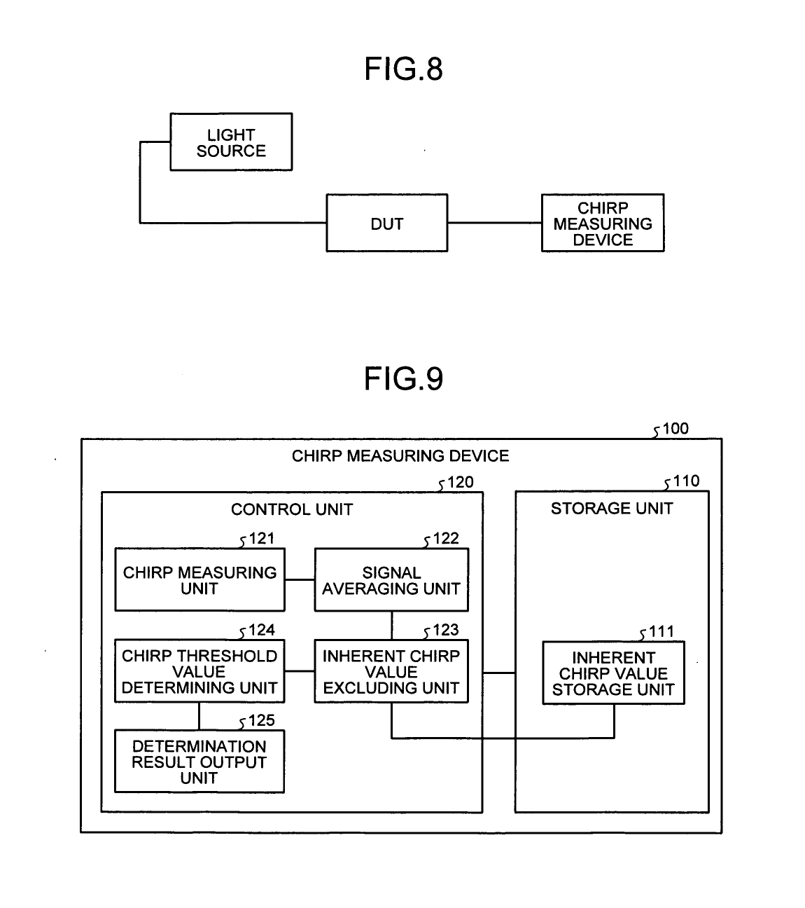

Next, it will be explained about the occurrence of a chirp with reference to FIGS. 2 to 7 and it will be explained about a chirp measuring device according to a second embodiment with reference to FIG. 8 to FIG. 13. A chirp is caused by the occurrence of a phase modulation. According to this, it will be below explained about the occurrence of a chirp cause by a phase modulator, the occurrence of a chirp caused by a fluctuation of a carrier frequency, and the occurrence of a chirp caused by a change of light intensity.

For example, when voltage is applied to a light guide by using a driving driver, a phase modulation occurs when a refractive index in the light guide is changed. In this case, for example, the time change “f_{c}(t)” of amplitude becomes Equation (1) assuming that an amplitude is “A”, a carrier frequency is “ω_{c}”, and a phase change caused by voltage is “θ₀(t)”. Moreover, Equation (1) can be expressed as Equation (2) when only phase information is considered. Then, Equation (2) becomes Equation (3) when time differentiation is performed to check the change of a phase.

f_{c}(t)=A cos(ω_{c}t+θ₀(t)) (1)

φ(t)=ω_{c}t+θ₀(t) (2)

\dot{φ}(t)=ω_{c}+\dot{θ}₀(t) (3)

In this case, Equation (3) is referred to as an instantaneous frequency. Equation (3) indicates how much the instantaneous frequency is deviated from a carrier frequency, the rotational position of a phase that should originally be and how a time change is shifted. The change from the carrier frequency becomes a chirp that is a time variation of an optical frequency (fluctuation of optical frequency).

FIG. 2 is a diagram illustrating an example of a time change (t) of a driving voltage (V) in a phase modulator. In the example illustrated in FIG. 2, the driving voltage “V” increases in a time interval “T1”, is constant in a time interval “T2”, and decreases in a time interval “T3”. For example, when a voltage variation that causes a phase change is as illustrated in FIG. 2 in an LN modulator that is an optical modulator that uses lithium niobate (LN:LiNbO₃) crystal, the instantaneous frequency becomes Equations (4), (5), and (6) from Equation (3) and FIG. 1.

\dot{φ}(t)=ω_{c}+\dot{θ}hd 0(t) if 0≦t≦T1 (4)

\dot{φ}(t)=ω_{c} if T1≦t≦T2 (5)

\dot{φ}(t)=ω_{c}+\dot{θ}₀(t) if T2≦t≦T3 (6)

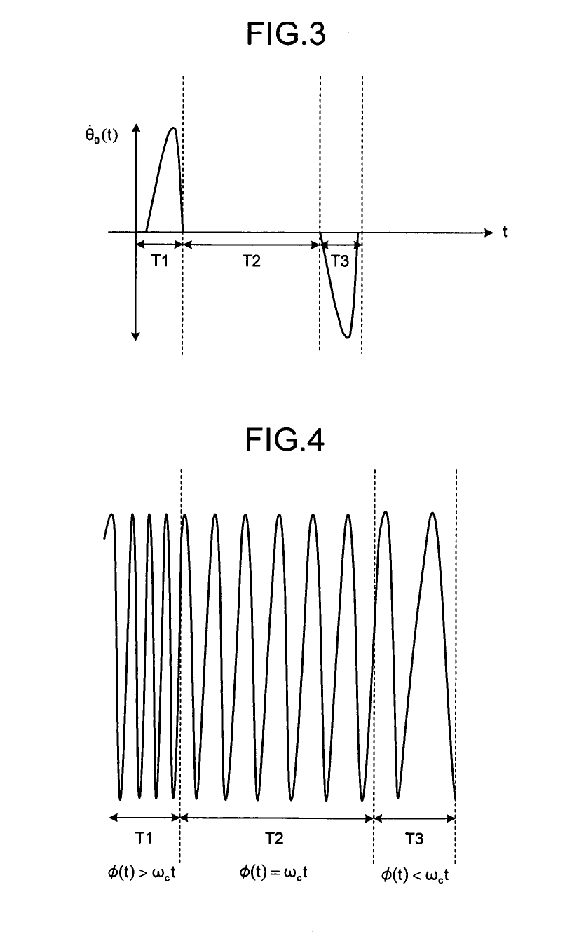

FIG. 3 is a diagram illustrating an example of a chirp that is a change from a carrier frequency. Moreover, FIG. 4 is a diagram illustrating an example of a phase change when chirps occur. In the example illustrated in FIG. 3, a chirp has a convex shape to the upper side in the time interval “T1”, a chirp is “0” in the time interval “T2”, and a chirp has a convex shape to the lower side in the time interval “T3”. In the action of the chirps illustrated in FIG. 3, a phase change causes a faster frequency or a slower frequency than the carrier frequency in the time intervals “T1”, “T2”, and “T3” from Inequalities (7) and (9) and Equation (8), as illustrated in FIG. 4.

φ(t)>ω_{c}t if 0≦t≦T1 (7)

φ(t)=ω_{c}t if T1≦t≦T2 (8)

φ(t)<ω_{c}t if T2≦t≦T3 (9)

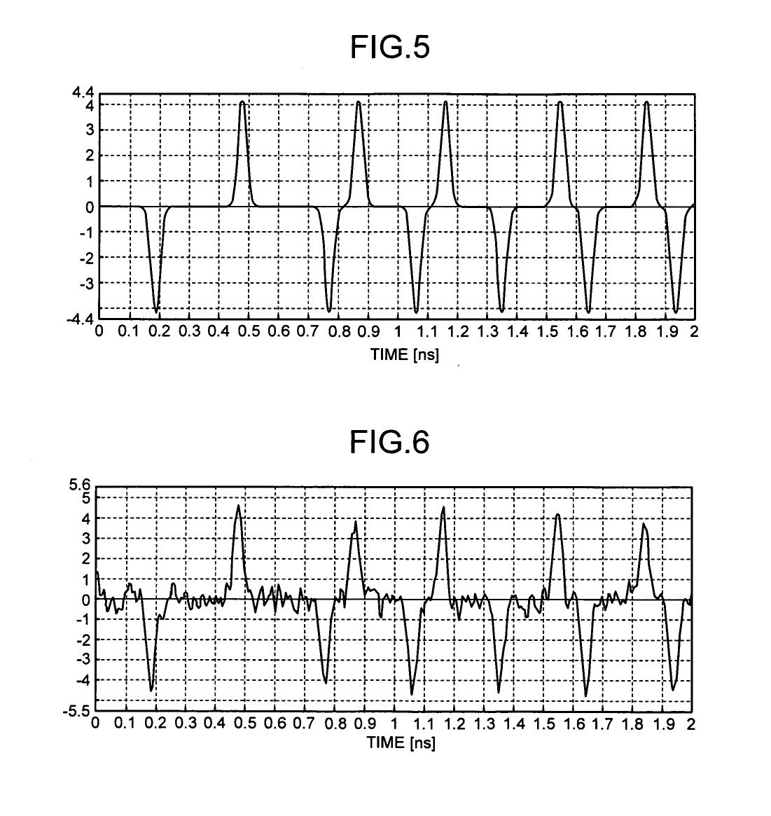

FIG. 5 is a diagram illustrating an example of a simulation result when a driving voltage driver makes a phase modulator generate a chirp. In this case, the action of the chirps illustrated in FIG. 3 can be adjusted in accordance with a design to some extent. According to this, the simulation result indicates that chirps occur while taking a chirp value “0” in an arbitrary time interval as illustrated in FIG. 5.

FIG. 6 is a diagram illustrating an example of a simulation result under a condition to which a fluctuation of a carrier frequency is added. However, as illustrated in FIG. 6, chirps that are obtained by an actual measurement further occurs randomly (actually, fluctuation of carrier frequency) without taking a chirp value “0” in an arbitrary time interval. In brief, in Equation (5), an actual carrier frequency has a limitary band rather than a band “0”. In other words, the actual carrier frequency has a fluctuation of a frequency of laser light. For this reason, Equation (3) can be expressed by Equation (10).

φ(t)=ω_{c}(t)+θ₀(t) where ω_{c}−Δω_{c}≦ω_{c}(t)≦ω_{c}+Δω (10)

Because the carrier frequency “ω_{c}” does not also become a constant value and occurs in random order in accordance with a time change when an instantaneous frequency is calculated in Equation (10), a chirp that can occur can be specified if another optical component such as a dielectric multilayer film or a lens is also produced as designed. However, Equation (2) becomes Equation (11) if there is a defect in the wave guide that gives an influence to a phase change by some kind of factors. The term “θₑᵣᵣₒᵣ(t)” of a phase change that is caused by a defect is added to Equation (11). When the time average of phase changes is taken in Equation (11), Equation (11) becomes Equation (12). In Equation (12), the time average is indicated with “< >”.

φ(t)=ω_{c}(t)+θ₀(t)+θₑᵣᵣₒᵣ(t) (11)

[symbol]

φ(t) [symbol] =ω_{c}+ [symbol] θ₀(t) [symbol] + [symbol] θₑᵣᵣₒᵣ(t) [symbol] if [symbol] ω_{c}(t) [symbol] ≈ω_{c} (12)

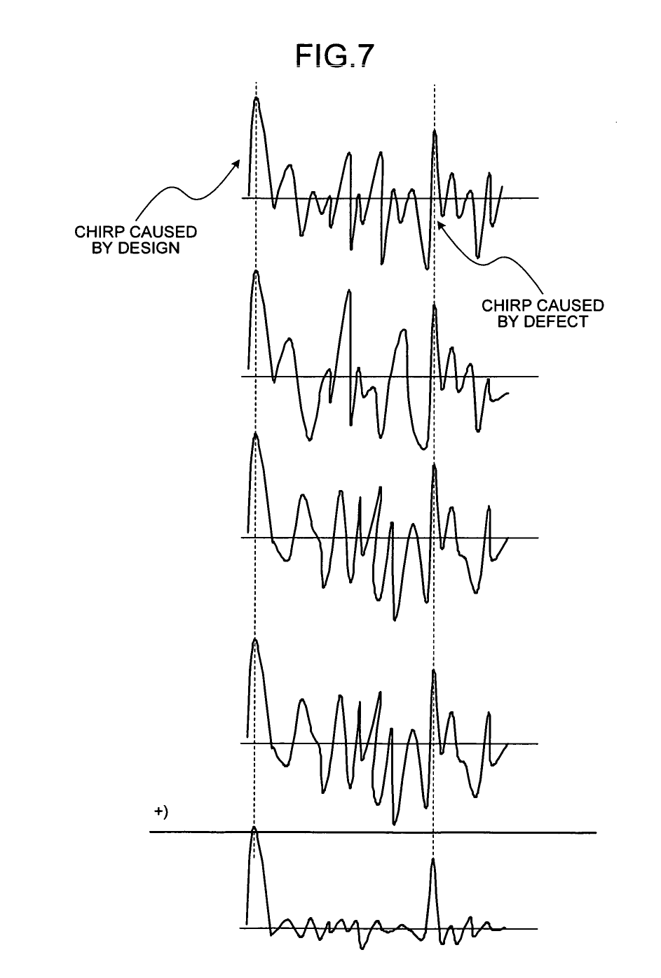

FIG. 7 is a diagram illustrating an example of a chirp detection according to a time average. In Equation (12), it is “ω_{c}=<ω_{c}(t)>”. As a result, chirps caused by the fluctuation of a frequency can be removed and the time average of chirps caused by a design and the time average of chirps caused by a defect can be obtained. For example, as illustrated in FIG. 7, chirps caused by a design and a defect are obtained as illustrated in the lower portion of FIG. 7 by taking the time average of a phase change for each of four time slots illustrated in the upper portion of FIG. 7.

System Configuration of Second Embodiment

Next, it will be explained about a configuration example of a testing system of an optical component that includes the chirp measuring device according to the second embodiment with reference to FIG. 8. FIG. 8 is a diagram illustrating a configuration example of a testing system of an optical component that includes the chirp measuring device according to the second embodiment.

For example, as illustrated in FIG. 8, the system according to the second embodiment includes a light source, a DUT (device under test), and the chirp measuring device. Among them, the light source outputs, for example, light that has a wavelength range used in an optical communication system and has a single wavelength that is not modulated. The DUT is, for example, a target device (optical component) for chirp measurement and is serially connected with the light source. Moreover, the chirp measuring device is further connected in series with, for example, the DUT. Hereinafter, it will be explained about the case where the DUT has some kind of defect.

In the above configuration, in the case of temporal measurement before the input into the DUT, for example, the fluctuation “ω_{c}” of the light source is measured. Then, after passing through the DUT, the chirp measuring device measures phase information to which the phase change “θ₀(t)” is added and the phase change “θₑᵣᵣₒᵣ(t)” caused by the defect of DUT is added. After that, the chirp measuring device computes an instantaneous frequency from the measured phase information and measures chirps. In addition, it will be below explained about the detailed information of chirp measurement that is performed by the chirp measuring device according to the second embodiment.

Configuration of Chirp Measuring Device of Second Embodiment

Next, it will be explained about the configuration example of a chirp measuring device 100 according to the second embodiment with reference to FIG. 9. FIG. 9 is a diagram illustrating the configuration example of the chirp measuring device 100 according to the second embodiment. For example, as illustrated in FIG. 9, the chirp measuring device 100 includes a storage unit 110 and a control unit 120.

The storage unit 110 stores therein data required for various types of processes performed by the control unit 120 and various types of processing results performed by the control unit 120, and includes an inherent chirp value storage unit 111. Moreover, the storage unit 110 is, for example, a semiconductor memory device such as a RAM (Random Access Memory), a ROM (Read Only Memory), or a flash memory or a storage device such as a hard disk or an optical disc.

The inherent chirp value storage unit 111 stores, for example, inherent chirp values (theoretical values) that are inherent to a device and are caused by the design of the device, in which the device is a target of which the chirp is measured by the chirp measuring device 100. The chirp values stored in the inherent chirp value storage unit 111 are inherent values to devices, and the inherent chirp value storage unit 111 stores different chirp values for devices.

The control unit 120 includes an internal memory that stores therein a control program, a program for defining various types of processing procedures and so on, and required data, and controls the chirp measuring device 100. Moreover, the control unit 120 includes a chirp measuring unit 121, a signal averaging unit 122, an inherent chirp value excluding unit 123, a chirp threshold value determining unit 124, and a determination result output unit 125. In this case, the control unit 120 is, for example, an integrated circuit such as ASIC (Application Specific Integrated Circuit) or FPGA (Field Programmable Gate Array) or an electronic circuit such as CPU (Central Processing Unit) or MPU (Micro Processing Unit).

The chirp measuring unit 121 measures chirps that include a chirp caused by a fluctuation of an optical frequency and a chirp caused when light passes through a defective part of DOT, for example, from input light signal that passes through the DUT, in which the DUT is a chirp measuring object. For example, the chirp measuring unit 121 then inputs the measured chirps into the signal averaging unit 122. In this case, the chirp measuring unit 121 may be an example of the chirp measuring unit 2.

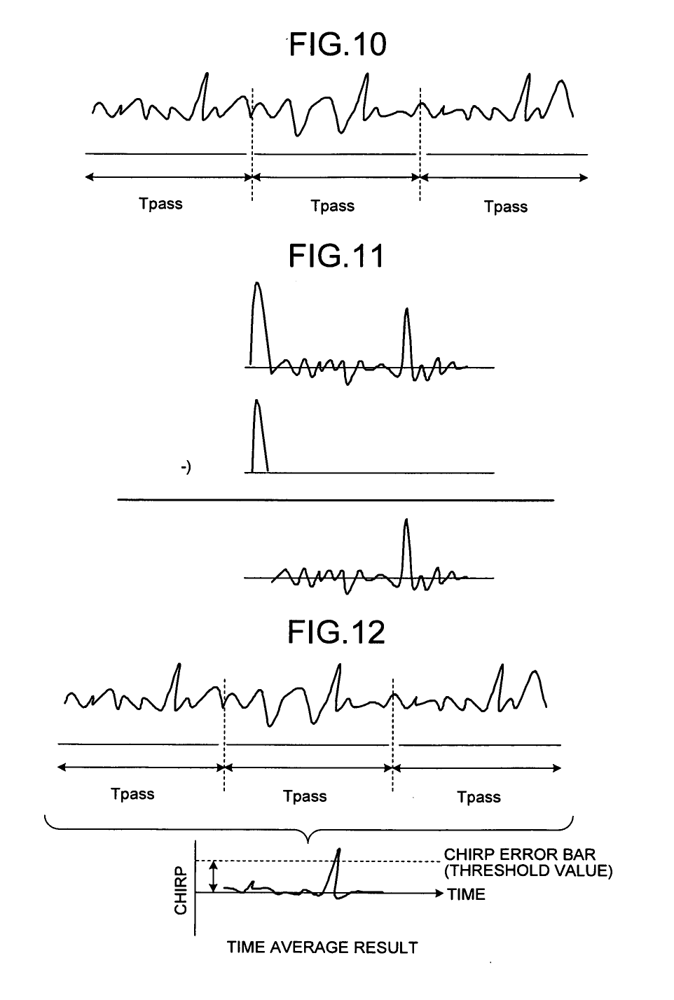

For example, the signal averaging unit 122 computes, based on the chirps measured by the chirp measuring unit 121, a time average for each predetermined time slot, and inputs the computed values into the inherent chirp value excluding unit 123. In the computation of a time average for each predetermined time slot performed by the signal averaging unit 122, a time average is computed from data for each passage time “Tpass” of the DUT, for example, as illustrated in FIG. 10. FIG. 10 is a diagram illustrating an example of a time average width that is set.

For example, when sampling data from “t(1), chirp(1)”, “t(j), chirp(j)”, . . . are obtained for each time interval “Tpass”, a time average can be computed by using Equation (13) when the average for the j-th data on the time axis is taken. Moreover, in Equation (13), “N” (N is a natural number) indicates the number of additions which is previously determined. In this case, the signal averaging unit 122 may be an example of the signal averaging unit 3.

$$〈 chirp ( j ) 〉 = \frac{1}{N} {\sum }_{i} chirp ( j ) \_i \qquad ( 13 )$$

For example, when an inherent chirp value caused by the design of the DUT exists, the inherent chirp value excluding unit 123 acquires the inherent chirp value from the inherent chirp value storage unit 111. Whether an inherent chirp value exists or not is preliminarily set. Then, the inherent chirp value excluding unit 123 excludes the inherent chirp value included in the time average computed by the signal averaging unit 122 and inputs the result into the chirp threshold value determining unit 124.

In the inherent chirp value exclusion process that is performed by the inherent chirp value excluding unit 123, the lower-stage result of FIG. 11 is obtained by subtracting the chirp caused by the design in the middle stage of FIG. 11 from the computation result of a time average in the upper stage of FIG. 11, for example, as illustrated in FIG. 11. FIG. 11 is a diagram illustrating an example of a process for excluding a chirp caused by a design.

The chirp threshold value determining unit 124 determines, for example, whether the chirp included in the time average, which does not have the inherent chirp value, output from the inherent chirp value excluding unit 123 is not less than a predetermined chirp threshold value and inputs the determined result into the determination result output unit 125. In this case, the chirp threshold value determining unit 124 may be an example of the chirp threshold value determining unit 4.

In the determination performed by the chirp threshold value determining unit 124, it is determined whether the chirp included in the time average computed in three time intervals “Tpass” is not less than the predetermined chirp threshold value (chirp error bar), for example, as illustrated in FIG. 12. For example, when a chirp amount of which the level has an influence on transmission quality in a transmission simulation is previously computed, the chirp error bar is set based on this chirp amount. FIG. 12 is a diagram illustrating an example of a determination process of a chirp error.

For example, when the determination result performed by the chirp threshold value determining unit 124 is not less than the chirp error bar, the determination result output unit 125 outputs “NG” that indicates the performance degradation of the DUT. Moreover, for example, when the determination result performed by the chirp threshold value determining unit 124 is less than the chirp error bar, the determination result output unit 125 outputs “OK” that indicates that the DUT is a non-defective product. The determination result output from the determination result output unit 125 is displayed on, for example, a display unit included in the chirp measuring device 100 or a predetermined display device such as an oscilloscope. In this case, the determination result output unit 125 may be an example of the determination result output unit 5.

In brief, in the chirp measurement performed by the chirp measuring device 100 according to the second embodiment, there are measured chirps that include a chirp caused by a fluctuation of an optical frequency, a chirp caused when light passes through a defective part of a DUT, and a chirp caused by a design of the DUT. Then, the chirp measuring device 100 smoothes the chirp caused by the fluctuation of the optical frequency by using the signal averaging unit 122 and excludes the chirp caused by the design by using the inherent chirp value excluding unit 123. After that, the chirp measuring device 100 determines that there is a defect when the chirp caused when light passes through the defective part of the DUT gives an influence on optical communication, in other words, when the chirp is not less than a predetermined chirp threshold value. In this case, when the chirp caused by the design does not exist, the chirp measuring device 100 only computes a time average without performing a process for excluding a chirp value caused by the design.

Chirp Measurement Process of Second Embodiment

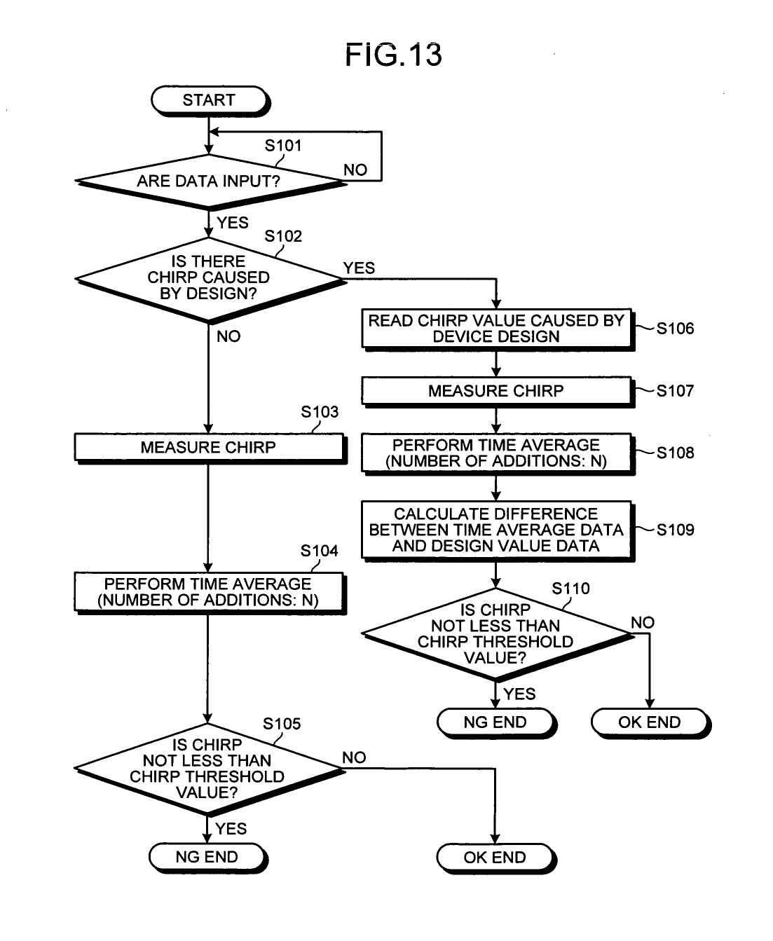

Next, it will be explained about a flow of a chirp measurement process according to the second embodiment with reference to FIG. 13. FIG. 13 is a flowchart of a chirp measurement process according to the second embodiment. In this case, the chirp measurement process means a process that is performed by the chirp measuring device 100 according to the second embodiment.

For example, as illustrated in FIG. 13, when light is output from the light source, passes through the DUT that is a chirp measuring target, and is input into the chirp measuring device 100 (Step S101: YES), the chirp measuring device 100 determines whether a chirp caused by a design exists (Step S102). In this case, when light is not input into the chirp measuring device 100 (Step S101: NO), the chirp measuring device 100 enters an input waiting state of input light signal.

Then, when the chirp caused by the design does not exist (Step S102: NO), the chirp measuring device 100 measures chirps (Step S103). At this time, the chirp measuring device 100 measures chirps that include a chirp caused by a fluctuation of an optical frequency and a chirp caused when light passes through a defective part of the DUT.

Next, the chirp measuring device 100 computes, based on the measured chirp, a time average (for example, the number of additions is “N”) for each predetermined time slot (Step S104). After that, the chirp measuring device 100 determines whether the chirp is not less than a predetermined chirp threshold value (Step S105).

Then, when the chirp is not less than the predetermined chirp threshold value (Step S105: YES), the chirp measuring device 100 outputs “NG” that indicates the performance degradation of the DUT. Moreover, when the chirp is less than the predetermined chirp threshold value (Step S105: NO), the chirp measuring device 100 outputs “OK” that indicates that the DUT is a non-defective product.

On the other hand, when the chirp caused by the design exists (Step S102: YES), the chirp measuring device 100 acquires an inherent chirp value caused by the device design of the DUT from the inherent chirp value storage unit 111 (Step S106). Then, the chirp measuring device 100 measures chirps (Step S107). At this time, the chirp measuring device 100 measures chirps that include the chirp caused by the fluctuation of the optical frequency, the chirp caused when light passes through the defective part of the DUT, and the chirp caused by the design of the DUT.

Next, the chirp measuring device 100 computes, based on the measured data, a time average (for example, the number of additions is “N”) for each predetermined time slot (Step S108). At this time, the chirp measuring device 100 smoothes the chirps that occur in random order due to the fluctuation of the optical frequency and outputs the chirps that include the chirp caused when light passes through the defective part of the DUT and the chirp caused by the design of the DUT.

After that, the chirp measuring device 100 calculates a difference between data obtained by performing the time average process and design value data that is a chirp value caused by the design in order to exclude the chirp value caused by the design (Step S109). At this time, the chirp measuring device 100 excludes the chirp value caused by the design and outputs a chirp that includes the chirp caused when light passes through the defective part of the DUT.

Then, when the chirp is not less than the predetermined chirp threshold value (Step S110: YES), the chirp measuring device 100 outputs “NG” that indicates the performance degradation of the DUT. On the other hand, when the chirp is less than the predetermined chirp threshold value (Step S110: NO), the chirp measuring device 100 outputs “OK” that indicates that the DUT is a non-defective product. In this case, an inherent chirp may be acquired from the inherent chirp value storage unit 111 after the time average computation process.

As described above, the chirp measuring device 100 outputs only the chirp caused when light passes through a defective part of an optical component among the measured chirps and determines that there is a defect when the output chirp is not less than a predetermined chirp threshold value. As a result, the chirp measuring device 100 can reduce a time for testing the optical component and perform a high-precision test. Moreover, because the chirp measuring device 100 is used for a deficiency test of an optical component by only adding a simple configuration to the existing chirp measuring device, the chirp measuring device 100 can perform the deficiency test more cheaply. Moreover, because the chirp measuring device 100 performs the deficiency test from the viewpoint of a chirp, an optical component, which has been determined as a deficiency in the deficiency test performed by a microscope or a visual inspection, can be relieved as a non-defective product.

### [c] Third Embodiment

It has been explained about the embodiments of the chirp measuring device disclosed above. Various different configurations other than the embodiments described above may be provided. Therefore, it will be explained about a different embodiment in view of: (1) timing of an additive average; (2) configuration of a chirp measuring device; and (3) program.

(1) Timing of Signal Averaging

It has been explained about the case in which an average is computed by signal averaging after chirps are measured in the first and second embodiments. However, a signal averaging may be first performed on data to be input into a chirp measuring device. In other words, the chirp measuring device computes an average of the input data, measures chirps for data obtained by smoothing a fluctuation component of an optical frequency that occurs in random order, and performs a threshold value determination on the measured chirps.

(2) Configuration of Chirp Measuring Device

Moreover, information (for example, measured chirps) including a processing procedure, a control procedure, a concrete title, various types of data and parameters, and the like that are indicated in the document, drawings, or the like can be arbitrarily changed except a specially mentioned case. For example, in the measurement of chirp, a chirp that is a convex shape to the lower side may be output depending on a specification of a device.

Moreover, each component of the illustrated base station and mobile communication terminal has a functional concept and these components are not necessarily constituted physically as illustrated in the drawings. In other words, the specific configuration of dispersion/integration of each device is not limited to the illustrated configuration. Therefore, all or a part of each device can be functionally or physically dispersed or integrated in an optional unit in accordance with various types of loads or operating conditions. For example, the signal averaging unit 122 and the inherent chirp value excluding unit 123 may be integrated as “a noise chirp excluding unit” that computes a time average of measured data and excludes a chirp caused by the design of the device.

(3) Program

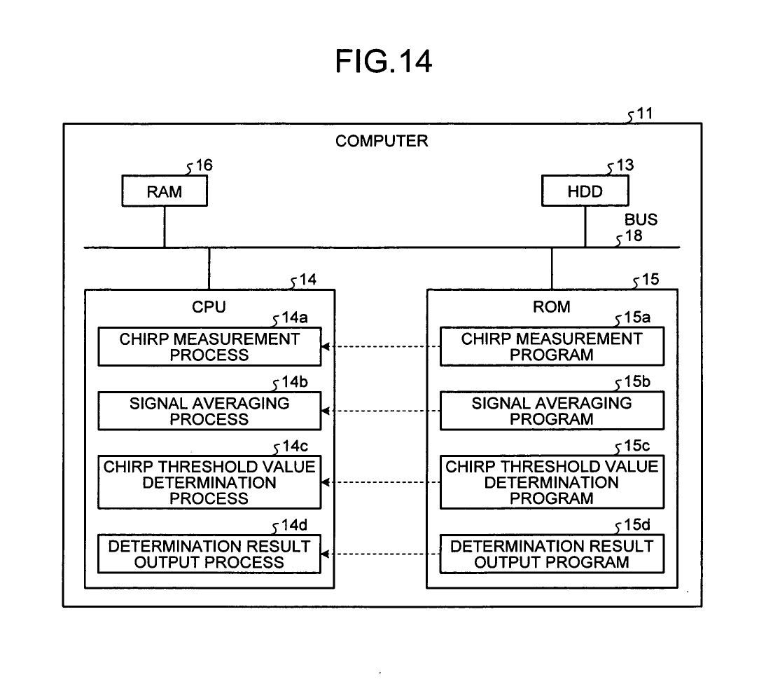

However, it has been explained about the case various types of processes are realized by hardware logic in the embodiment. However, various types of processes may be realized by executing a previously prepared program by a computer. Hereinafter, it will be explained about an example of a computer that executes a chirp measurement program having substantially the same function as that of the chirp measuring device 1 described in the embodiments with reference to FIG. 14. FIG. 14 is a diagram illustrating an example of a computer 11 that executes a chirp measurement program.

As illustrated in FIG. 14, the computer 11 that functions as the chirp measuring device 1 includes an HDD 13, a CPU 14, a ROM 15, a RAM 16, and the like that are connected to each other by a bus 18.

The ROM 15 previously stores therein the chirp measurement program having substantially the same function as that of the chirp measuring device 1 described in the embodiments, in other words, a chirp measurement program 15a, a signal averaging program 15b, a chirp threshold value determination program 15c, and a determination result output program 15d as illustrated in FIG. 14. In this case, these programs 15a to 15d may be appropriately integrated or dispersed similarly to each component of the chirp measuring device 1 illustrated in FIG. 1.

The CPU 14 reads out these programs 15a to 15d from the ROM 15 and executes them. As a result, as illustrated in FIG. 14, the programs 15a to 15d function as a chirp measurement process 14a, a signal averaging process 14b, a chirp threshold value determination process 14c, and a determination result output process 14d. In this case, the processes 14a to 14d correspond to the chirp measuring unit 2, the signal averaging unit 3, the chirp threshold value determining unit 4, and the determination result output unit 5 as illustrated in FIG. 1. Moreover, the CPU 14 executes, based on the data recorded in the RAM 16, the chirp measurement program.

Each of the programs 15a to 15d should not be necessarily stored in the ROM 15 from the start. For example, each program may be stored in a “portable physical medium” such as a flexible disk (FD), a CD-ROM, a DVD disk, a magneto-optical disk, and an IC card that are inserted into the computer 11, a “fixed physical medium” such as an HDD provided inside and outside the computer 11, or further “another computer (or server)” that is connected to the computer 11 via a public line, the Internet, LAN, WAN, or the like, so that the computer 11 can read out and execute the programs from the above media.

According to an aspect of the chirp measuring device, the chirp measurement program, and the chirp measurement method disclosed in the present application, the test time of an optical component can be reduced and a high-precision test can be realized.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A chirp measuring device comprising:
a chirp measuring unit that measures chirps indicating a time variation of an optical frequency of input light signal;
a signal averaging unit that computes, based on a predetermined number of additions for signal averaging, an average of the chirps measured by the chirp measuring unit;
a chirp threshold value determining unit that determines whether the average computed by the signal averaging unit is not less than a predetermined chirp threshold value; and
a determination result output unit that outputs a determination result obtained by the chirp threshold value determining unit.

2. The chirp measuring device according to claim 1, further comprising:
an inherent chirp value storage unit that stores therein an inherent chirp value inherent to a device to be measured, the inherent chirp value being known in a design of the device; and
an inherent chirp value excluding unit that acquires the inherent chirp value from the inherent chirp value storage unit and excludes the inherent chirp value included in the average computed by the signal averaging unit, and
the chirp threshold value determining unit determines whether a value obtained by excluding the inherent chirp value from the average by the inherent chirp value excluding unit is not less than the predetermined chirp threshold value.

3. A computer readable storage medium having stored therein a chirp measuring program causing a computer to execute a process comprising:
measuring chirps indicating a time variation of an optical frequency of input light signal;
computing an average of the measured chirps, based on a predetermined number of additions for signal averaging;
determining whether the computed average is not less than a predetermined chirp threshold value; and
outputting a determination result obtained at the determining.

4. A chirp measuring method comprising:
measuring chirps indicating a time variation of an optical frequency of input light signal;
computing an average of the measured chirps, based on a predetermined number of additions for signal averaging;
determining whether the computed average is not less than a predetermined chirp threshold value; and
outputting a determination result obtained at the determining.
